(19) United States
(12) Patent Application Publication
(10) Pub. No.: US 2016/0248591 A1
(43) Pub. Date: Aug. 25, 2016

(54) FIRMWARE WATERMARKING METHOD, FIRMWARE BASED ON THE SAME, AND APPARATUS FOR PERFORMING FIRMWARE WATERMARKING

(71) Applicant: ELECTRONICS AND TELECOMMUNICATIONS RESEARCH INSTITUTE, Daejeon (KR)

(72) Inventors: Byeong-Cheol CHOI, Daejeon (KR); Jung-Chan NA, Daejeon (KR)

(21) Appl. No.: 15/050,133

(22) Filed: Feb. 22, 2016

(30) Foreign Application Priority Data
Feb. 25, 2015 (KR) 10-2015-0026231

(51) Int. Cl. H04L 9/32; H04L 9/08; G06F 21/16; H04L 29/06

(52) U.S. Cl. CPC H04L 9/3247; H04L 63/06; H04L 9/0861; G06F 21/16

(57) ABSTRACT

Disclosed herein are a firmware watermarking method, firmware based on the method, and an apparatus for performing firmware watermarking, which can provide a basis for legally preparing for firmware modification attacks by embedding a watermark for original firmware in nonvolatile memory at the time of manufacturing embedded devices. The presented method is a firmware watermarking method performed by an apparatus for performing the firmware watermarking method, the method including generating an original watermark for firmware, and embedding the generated original watermark in the firmware.

### CROSS REFERENCE TO RELATED APPLICATION

This application claims the benefit of Korean Patent Application No. 10-2015-0026231, filed Feb. 25, 2015, which is hereby incorporated by reference in its entirety into this application.

### BACKGROUND OF THE INVENTION

1. Technical Field

The present invention generally relates to a firmware watermarking method, firmware based on the method, and an apparatus for performing firmware watermarking, and more particularly to a firmware watermarking method, firmware based on the method, and an apparatus for performing firmware watermarking, which can provide a basis for legally preparing for the forgery/modification of firmware in the Internet of Things (IoT) and embedded devices by embedding a watermark for of original firmware at the time of manufacture to ensure preparedness in the event of firmware forgery/modification.

2. Description of the Related Art

Firmware, which is core software for operating hardware devices, such as embedded devices, is disposed in Nonvolatile Memory (NVM) 100, as shown in FIG. 1.

Firmware 10 includes a bootloader (or bootstrap) area including a magic signature, a boot code address, an integrity check value, a checksum (CRC-32), etc., a firmware metadata area including manufacturing information such as the manufacturer, device ID, and firmware version, and a firmware core area including information such as a boot code and a kernel.

Requirements for firmware security have increased recently in the IoT field, as well as in existing embedded device fields.

However, it is difficult to be prepared for firmware modification attacks using only the existing firmware security method.

Since the firmware 10 may be attacked someday due to the problem of key management even if the firmware 10 is encrypted, firmware cannot be completely safe from modification attacks.

As preceding technologies related to the present invention, there are disclosed Korean Patent Application Publication No. 2007-0017455 (entitled “Secure Protection Method for Access to Protected Resources in a Processor”), Korean Patent Application Publication No. 2011-0066707 (entitled “Method for Implementing Key Sharing and Update Mechanism Utilizing Watermark”), and Korean Patent Application Publication No. 2014-0070203 (entitled “Apparatus for Integrity Verification of Firmware of Embedded System and Method thereof”).

### SUMMARY OF THE INVENTION

Accordingly, the present invention has been made keeping in mind the above problems occurring in the prior art, and an object of the present invention is to provide a firmware watermarking method, firmware based on the method, and an apparatus for performing firmware watermarking, which can provide a basis for legally preparing for firmware modification attacks by embedding a watermark for original firmware in nonvolatile memory at the time of manufacturing embedded devices.

In accordance with an aspect of the present invention to accomplish the above object, there is provided a firmware watermarking method, the method being performed by an apparatus for performing the firmware watermarking method, the method including generating an original watermark for firmware; and embedding the generated original watermark in the firmware.

The firmware watermarking method may further include, as certain firmware is loaded, determining whether the firmware has been modified.

Determining whether the firmware has been modified may be performed by comparing a firmware watermark present in the firmware with the original watermark.

When the firmware watermark present in the firmware does not match the original watermark, it may be determined that currently loaded firmware has been modified.

Generating the original watermark for the firmware may include extracting significant information from the firmware and generating a firmware signature based on the extracted significant information and a secret key; and generating the original watermark based on the generated firmware signature and the secret key.

Generating the original watermark based on the generated firmware signature and the secret key may include generating the original watermark by performing XOR encryption on the generated firmware signature and the secret key.

The secret key may be managed by a firmware manufacturer.

The firmware watermarking method may further include storing the generated original watermark in a firmware database.

The firmware database may store secret keys and original watermarks for respective embedded device IDs.

In accordance with another aspect of the present invention to accomplish the above object, there is provided firmware, including an original watermark generated based on a firmware signature and a secret key, wherein the firmware signature is generated based on significant information, present in certain firmware, and the secret key.

The original watermark may be generated by performing XOR encryption on the firmware signature and the secret key.

In accordance with a further aspect of the present invention to accomplish the above object, there is provided an apparatus, including a key generation unit for generating secret keys; a firmware database for storing the secret keys from the key generation unit and storing original watermarks generated for respective firmware components; and a management unit for controlling generation of each original watermark, storing the generated original watermark in the firmware database, embedding the generated original watermark in corresponding firmware, and controlling a comparison between a firmware watermark of currently loaded firmware and the original watermark.

The management unit may be configured to compare the firmware watermark of the currently loaded firmware with the original watermark, and determine that the currently loaded firmware has not been forged/modified if the watermarks match each other.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram of existing firmware;

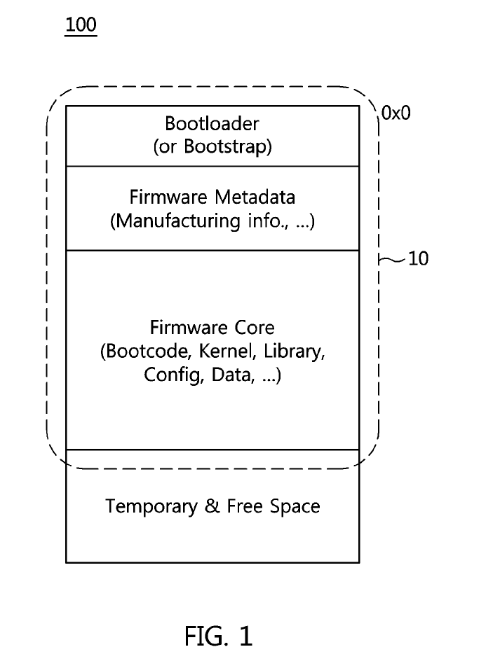

FIG. 2 is a configuration diagram of firmware according to the present invention;

FIG. 3 is a flowchart showing a firmware watermarking method according to an embodiment of the present invention;

FIG. 4 is a flowchart showing a firmware watermarking method according to another embodiment of the present invention;

FIG. 5 is a configuration diagram showing an apparatus for performing a firmware watermarking method according to the present invention; and

FIG. 6 is a diagram showing a computer system in which an embodiment of the present invention is implemented.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

The present invention may be used by the owner of an embedded device and firmware at the level of a digital forensics service.

The present invention is based on logic for responding to firmware modification attacks from the standpoint of digital forensics in response to firmware modification attacks. That is, when firmware is maliciously forged/modified by firmware modification attacks, the present invention may utilize such logic as legal response data. In other words, the present invention may be understood to be a security device which prevents device manufacturers from assuming legal responsibility for the occurrence of attacks even if it is difficult to defend against attacks.

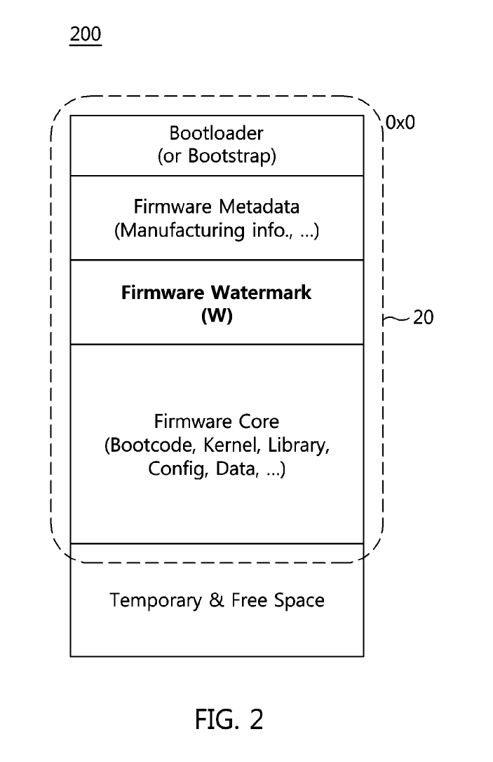

FIG. 2 is a configuration diagram of firmware according to the present invention. Firmware 20 according to the present invention is located in a nonvolatile memory (NVM) area 200, and includes a bootloader area, a firmware metadata area, and a firmware core area, in the same manner as existing firmware.

The difference in structure between the firmware 20 and existing firmware is that the firmware 20 according to the present invention additionally includes an Exclusive OR (XOR) encryption-based firmware watermark (W).

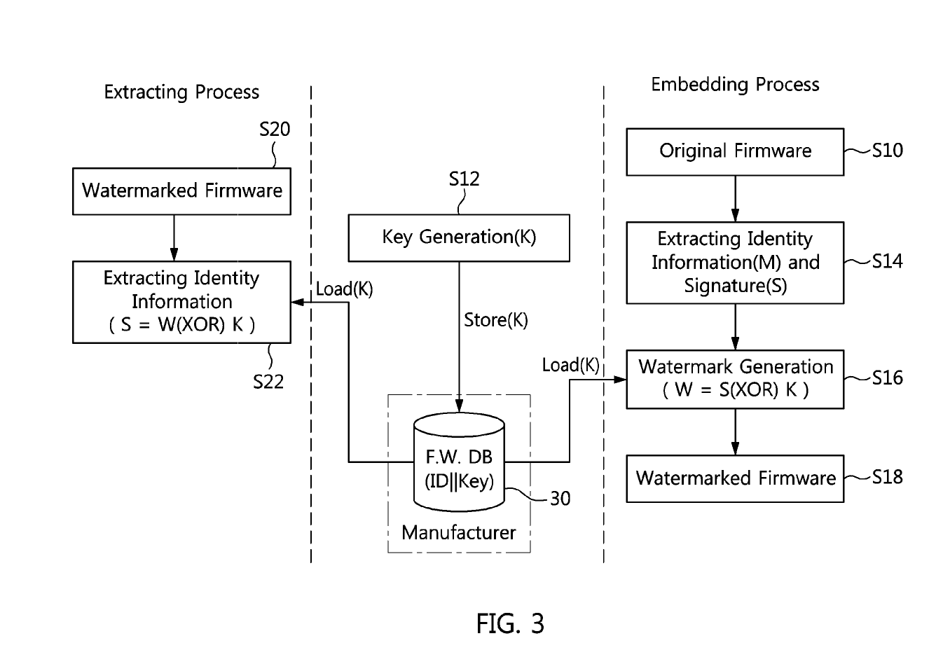

FIG. 3 is a flowchart showing a firmware watermarking method according to an embodiment of the present invention.

First, for firmware watermarking, original firmware is prepared at step S10.

Then, a secret key K for the prepared original firmware is generated at step S12, and the generated secret key K is stored in a firmware database (DB) 30. Here, the secret key K is configured to be managed by a device and firmware manufacturer (the agent of legal right and distribution). For example, the firmware DB 30 may store secret keys K for respective embedded device IDs corresponding to original firmware components.

Then, significant information (message: M) (e.g. manufacturer information, embedded device IDs, integrity information (including hash values), etc.) is extracted from the prepared original firmware, and a firmware signature (S) is generated based on the extracted significant information M and the secret key K at step S14. Here, the significant information M may be regarded as identity information. In the present invention, the firmware signature S may be generated based on, for example, a keyed-hash message authentication code (HMAC). This may be represented by the following Equation (1):

$$\begin{matrix}S = HMAC ( M ) \\ = H ( K ‖ H ( K ‖ M ) )\end{matrix} \qquad ( 1 )$$

The meaning of Equation (1) is “Hash(key∥Hash (key∥message))”. Further, as the hash function, Message Digest 5 (MD5), SHA-1, or SHA-256 may be used.

Thereafter, firmware watermark W is generated based on the generated firmware signature S and the secret key K at step S16. Here, in the present invention, the firmware watermark W may be generated based on XOR encryption. This may be represented by the following Equation (2):

W=S(XOR)K (2)

where
W: firmware watermark
S: firmware signature
K: secret key

Then, the generated firmware watermark W is embedded in the firmware 20 (watermarked firmware) at step S18.

In this way, the firmware watermark W may be embedded in the firmware 20.

Thereafter, when firmware having any firmware watermark W is loaded by a third party at step S20, significant information M is extracted from the currently loaded firmware, and the firmware signature S of the currently loaded firmware may be determined based on the extracted significant information M and the secret key K stored in the firmware DB 30 at step S22. Further, since “S=W(XOR)K” is satisfied, the firmware watermark W of the currently loaded firmware may be determined.

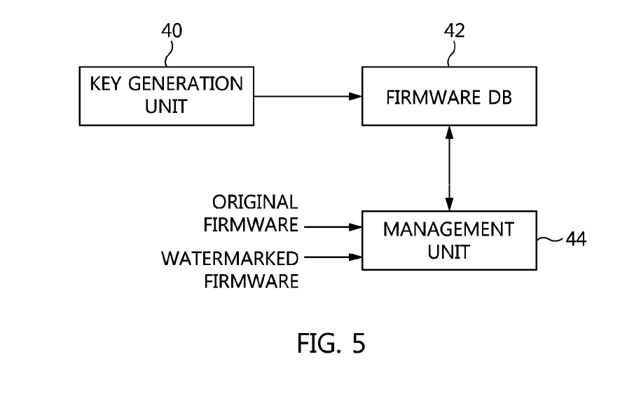

In FIG. 3, step S12 may be understood to be performed by the key generation unit 40 of FIG. 5, which will be described later, and steps S14 to S18 and step S22 may be understood to be performed by the management unit 44 of FIG. 5, which will be described later.

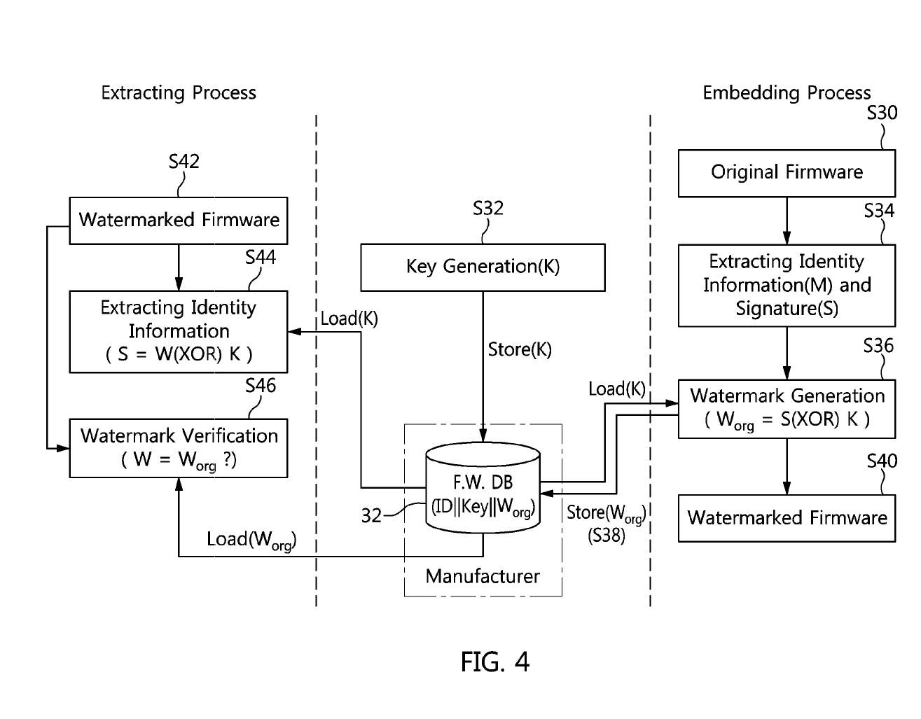

FIG. 4 is a flowchart showing a firmware watermarking method according to another embodiment of the present invention. The process of FIG. 4 is almost identical to that of FIG. 3.

First, original firmware is prepared for firmware watermarking at step S30.

Then, a secret key K for the prepared original firmware is generated at step S32, and the secret key K is stored in a firmware DB 32.

Thereafter, significant (identity) information M is extracted from the prepared original firmware, and a firmware signature S is generated based on the extracted significant information M and the secret key K at step S34. For example, the firmware signature S may be generated based on, for example, HMAC (keyed hash). This may be represented by the above-described Equation (1).

Thereafter, a firmware watermark W is generated based on the generated firmware signature S and the secret key K at step S36. Here, the firmware watermark W may be generated based on XOR encryption. This may be represented by the above-described Equation (2).

Further, the generated firmware watermark W is set as original watermark W_{org} for the corresponding original firmware, and is stored in the firmware DB 32 at step S38, and the original watermark W_{org} is embedded in the original firmware (watermarked firmware) at step S40. For example, the firmware DB 32 may store secret keys K and original watermarks W_{org} for respective embedded device IDs corresponding to the original firmware components.

In the above-described embodiments of the present invention, the secret key K is used twice to generate the firmware watermark W. However, the secret key (K or K_{S}), which is used to generate a firmware signature S depending on the requirements of the developer and the user, and the secret key (K or K_{W}), which is used to generate a final firmware watermark W, may be differently set.

When this process is performed, the firmware W (i.e. original watermark W_{org}) may be embedded in the original firmware 20. Meanwhile, in order to extract the firmware watermark W embedded in the original firmware 20, the conversion operation in the above-described procedure of embedding the firmware watermark W may be performed in reverse.

Next, when firmware having any firmware watermark W is loaded by a third party at step S42, significant information M is extracted from the currently loaded firmware, and the firmware signature S of the currently loaded firmware may be determined based on the extracted significant information M and the secret key K stored in the firmware DB 32 at step S44. Further, since “S=W(XOR)K” is satisfied, the firmware watermark W of the currently loaded firmware may be determined.

Thereafter, the original watermark W_{org} of the corresponding firmware stored in the firmware DB 32 is loaded, and then it is verified whether the firmware watermark W of the currently loaded firmware matches the loaded original watermark W_{org} by comparing the watermarks with each other at step S46.

If the watermarks match each other, it is determined that the currently loaded firmware has not been forged/modified, whereas if the watermarks do not match each other, it is determined that the currently loaded firmware has been forged/modified.

That is, even if a third party damages (modifies) the integrity information of the firmware, it is difficult to know which type of watermark is present in the corresponding firmware. Therefore, if the watermark of the currently loaded firmware is compared with a previously stored original watermark, the forgery/modification of the firmware may be determined. Further, even if a third party randomly generates a watermark and embeds it in firmware, when the generated watermark does not match the original watermark, it may be determined that such a modification has been made due to a malicious attack by the third party, and thus a device manufacturer need not assume legal responsibility. Of course, if a third party modifies the remaining information present in the firmware without taking into consideration the watermark, the watermark will not be present in the firmware, so that it may be easily determined that such a modification has been made due to the malicious attack by the third party, thus preventing the device manufacturer from assuming responsibility for such an attack.

In FIG. 4, it may be understood that step S32 is performed by the key generation unit 40 of FIG. 5, which will be described later, and steps S34 to S40 and S44 to S46 are performed by the management unit 44 of FIG. 5, which will be described later.

FIG. 5 is a configuration diagram showing an apparatus for performing a firmware watermarking method according to the present invention.

The apparatus for performing the firmware watermarking method according to the present invention includes a key generation unit 40, a firmware DB 42, and a management unit 44.

The key generation unit 40 may generate secret keys K for respective embedded devices.

The firmware DB 42 stores the secret keys K from the key generation unit 40. Further, the firmware DB 42 stores original watermarks W_{org} for respective original firmware components. In other words, the firmware DB 42 may store secret keys K and original watermarks W_{org} for respective embedded device IDs corresponding to the original firmware components.

The management unit 44 controls the generation of the original watermark W_{org} of the corresponding original firmware, stores the generated original watermark W_{org} in the firmware DB 42 while embedding (recording) the original watermark in the original firmware, and controls the comparison between the firmware watermark W of currently loaded firmware and the original watermark W_{org}.

The management unit 44 compares the firmware watermark W of the currently loaded firmware with the loaded original watermark W_{org}, and if the watermarks match each other, determines that the currently loaded firmware has not been forged/modified, whereas if the watermarks do not match each other, determines that the currently loaded firmware has been forged/modified.

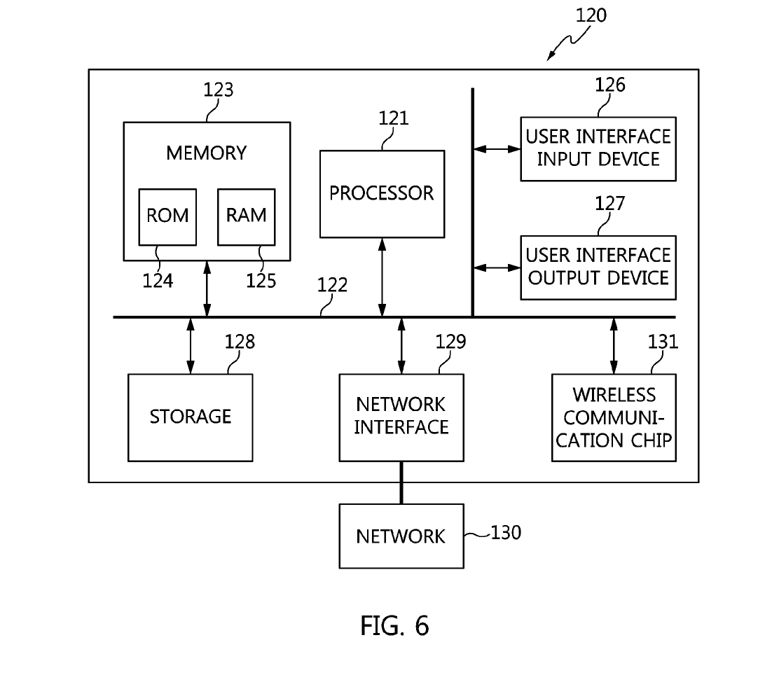

Meanwhile, the embodiment of the present invention may be implemented in a computer system. As shown in FIG. 6, a computer system 120 includes one or more processors 121, memory 123, a user interface input device 126, a user interface output device 127, and storage 128, which communicate with each other through a bus 122. The computer system 120 may further include one or more network interfaces 129 connected to a network 130. Each processor 121 may be a Central Processing Unit (CPU) or a semiconductor device for executing processing instructions stored in the memory 123 or the storage 128. Each of the memory 123 and the storage 128 may be any of various types of volatile or nonvolatile storage media. For example, the memory 123 may include Read Only Memory (ROM) 124 or Random Access Memory (RAM) 125.

Further, when the computer system 120 is implemented in a small-sized computing device in preparation for the IoT age, if an Ethernet cable is connected to the computing device, the computing device may function as a wireless sharer, so that a mobile device may be coupled in a wireless manner to a gateway to perform encryption/decryption functions. Therefore, the computer system 120 may further include a wireless communication chip (WiFi chip) 131.

Therefore, the embodiment of the present invention may be implemented as a non-temporary computer-readable storage medium in which a computer-implemented method or computer-executable instructions are recorded. When the computer-readable instructions are executed by a processor, the instructions may perform the method according to at least one aspect of the present invention.

In accordance with the present invention having the above configuration, a watermark for original firmware is embedded at the time of manufacture in preparation for firmware forgery/modification of IoT and embedded devices, thus enabling pre-emptive defense and post-attack legal response to firmware modification attacks, and enabling integrity to be verified in real time/non-real time in relation to whether firmware has been modified.

That is, when a problem occurs in a device or a system due to cyber or physical attacks, the present invention may be used not only in the legal response related to the field of digital forensics, but also in the real-time/non-real-time verification of firmware integrity.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A firmware watermarking method, the method being performed by an apparatus for performing the firmware watermarking method, the method comprising:
generating an original watermark for firmware; and
embedding the generated original watermark in the firmware.

2. The firmware watermarking method of claim 1, further comprising, as certain firmware is loaded, determining whether the firmware has been modified.

3. The firmware watermarking method of claim 2, wherein determining whether the firmware has been modified is performed by comparing a firmware watermark present in the firmware with the original watermark.

4. The firmware watermarking method of claim 3, wherein when the firmware watermark present in the firmware does not match the original watermark, it is determined that currently loaded firmware has been modified.

5. The firmware watermarking method of claim 1, wherein generating the original watermark for the firmware comprises:
extracting significant information from the firmware and generating a firmware signature based on the extracted significant information and a secret key; and
generating the original watermark based on the generated firmware signature and the secret key.

6. The firmware watermarking method of claim 5, wherein generating the original watermark based on the generated firmware signature and the secret key comprises generating the original watermark by performing XOR encryption on the generated firmware signature and the secret key.

7. The firmware watermarking method of claim 5, wherein the secret key is managed by a firmware manufacturer.

8. The firmware watermarking method of claim 1, further comprising storing the generated original watermark in a firmware database.

9. The firmware watermarking method of claim 8, wherein the firmware database stores secret keys and original watermarks for respective embedded device IDs.

10. Firmware, comprising:
an original watermark generated based on a firmware signature and a secret key, wherein the firmware signature is generated based on significant information, present in certain firmware, and the secret key.

11. The firmware of claim 10, wherein the secret key is managed by a firmware manufacturer.

12. The firmware of claim 11, wherein the original watermark is generated by performing XOR encryption on the firmware signature and the secret key.

13. An apparatus for performing firmware watermarking, comprising:
a key generation unit for generating secret keys;
a firmware database for storing the secret keys from the key generation unit and storing original watermarks generated for respective firmware components; and
a management unit for controlling generation of each original watermark, storing the generated original watermark in the firmware database, embedding the generated original watermark in corresponding firmware, and controlling a comparison between a firmware watermark of currently loaded firmware and the original watermark.

14. The apparatus of claim 13, wherein the management unit is configured to compare the firmware watermark of the currently loaded firmware with the original watermark, and determine that the currently loaded firmware has not been forged/modified if the watermarks match each other.
